(19) United States
(12) Patent Application Publication
(10) Pub. No.: US 2013/0265964 A1
(43) Pub. Date: Oct. 10, 2013

(54) WIRELESS CONTROL APPARATUS, WIRELESS TERMINAL APPARATUS, WIRELESS COMMUNICATION SYSTEM, CONTROL PROGRAM OF WIRELESS CONTROL APPARATUS AND WIRELESS TERMINAL APPARATUS AND INTEGRATED CIRCUIT

(71) Applicants: Kazunari Yokomakura, Osaka-shi (JP); Yasuhiro Hamaguchi, Osaka-shi (JP); Osamu Nakamura, Osaka-shi (JP); Jungo Goto, Osaka-shi (JP); Hiroki Takahashi, Osaka-shi (JP)

(72) Inventors: Kazunari Yokomakura, Osaka-shi (JP); Yasuhiro Hamaguchi, Osaka-shi (JP); Osamu Nakamura, Osaka-shi (JP); Jungo Goto, Osaka-shi (JP); Hiroki Takahashi, Osaka-shi (JP)

(73) Assignee: SHARP KABUSHIKI KAISHA, Osaka-shi, Osaka (JP)

(21) Appl. No.: 13/884,871

(22) PCT Filed: Nov. 4, 2011
(86) PCT No.: PCT/JP2011/075467

§ 371 Date: Jun. 25, 2013

(30) Foreign Application Priority Data
Nov. 12, 2010 (JP) 2010-253818

(51) Int. Cl. H04W 72/04

(52) U.S. Cl. CPC H04W 72/0406
USPC 370/329

(57) ABSTRACT

When a mobile station apparatus uses a multi-antenna, spectrum efficiency is improved with clipping performed on a transmission signal from the mobile station apparatus. There is provided a wireless control apparatus applied to a wireless communication system that performs clipping processing not to transmit a spectrum of part of a frequency domain so as to transmit and receive data, the wireless control apparatus, based on channel state information with a wireless terminal apparatus which is a destination, generates clipping information indicating a frequency domain where the clipping processing is performed and determines frequency allocation for the wireless terminal apparatus to generate frequency allocation information, and notifies the wireless terminal apparatus of the clipping information and the frequency allocation information.

### TECHNICAL FIELD

The present invention relates to a spectrum clipping method when a multi-antenna is used.

### BACKGROUND ART

The standardization of a LTE (Long Term Evolution) system that is the wireless communication system of the 3.9th generation mobile telephones has been almost completed, and LTE-A (LTE-Advanced) that is developed more than the LTE system has recently been standardized as one candidate of the fourth generation wireless communication system (referred also to as IMT-A). In general, since in the uplink (communication from a mobile station to a base station) of a mobile communication system, the mobile station functions as a transmission station, a single carrier scheme (in the LTE, a SC-FDMA (Single Carrier Frequency Division Multiple Access) scheme is adopted) is regarded to be effective, which can maintain the high power efficiency of an amplifier with a limited amount of transmit power and in which a peak power is low. The SC-FDMA is also referred to as a DFT-S-OFDM (Discrete Fourier Transform Spread Orthogonal Frequency Division Multiplexing), a DFT-precoded OFDM or the like.

In the LTE-A, in order to further improve spectrum efficiency, it is determined that, in a terminal having an extra amount of transmit power, a SC-FDMA spectrum is divided into clusters formed with a plurality of subcarriers, and that an access scheme called Clustered DFT-S-OFDM (referred also to as Dynamic Spectrum Control (DSC), SC-ASA (Single Carrier Adaptive Spectrum Allocation) or the like) is newly supported, in which each cluster is arranged in an arbitrary frequency on a frequency axis. Furthermore, a technique is proposed in which, on assumption that turbo-equalization is performed in reception processing, spectral shaping including clipping is performed on a frequency signal from each mobile station apparatus to improve spectrum efficiency (for example, see non-patent document 1).

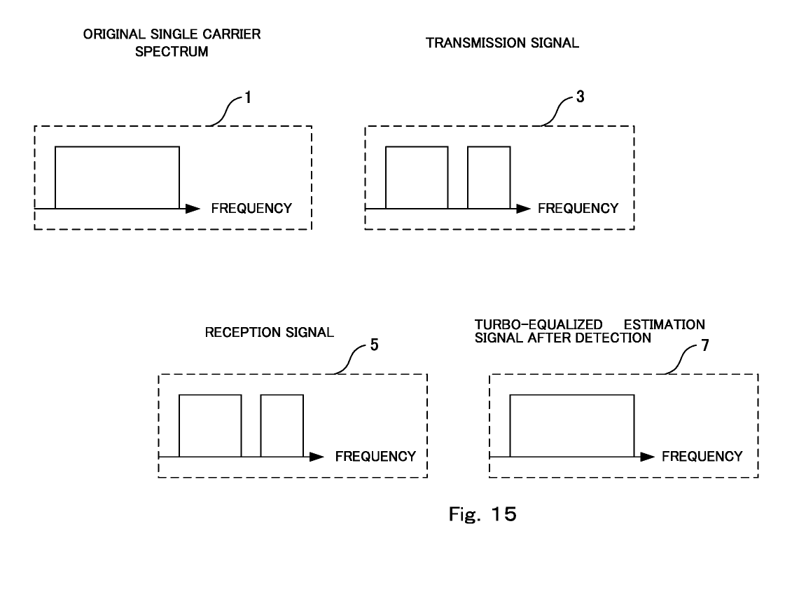

FIG. 15 is a diagram showing a concept of a spectrum clipping disclosed in non-patent document 1. A unit of a frequency signal is clipped (deleted) from an original single carrier spectrum 1, and thus a transmission signal 3 is generated. In this case, the frequency signal is clipped according to channel state performances. In a reception signal 5 is received in the transmission side with a natural state, as a matter of course, in which the clipped frequency signal is deleted. Thereafter, detection is performed by turbo-equalization on the assumption that the channel gain of the frequency of the clipped signal is zero, and thus it is possible to reproduce the frequency signal as with an estimation signal 7.

Non-patent document 1: A. Okada, S. Ibi, S. Sampei, “Spectrum Shaping Technique Combined with SC/MMSE Turbo Equalizer for High Spectral Efficient Broadband Wireless Access Systems,” ICSPCS2007, Gold Coast, Australia, December 2007.

### DISCLOSURE OF THE INVENTION

However, a method of applying clipping to a multi-antenna technology (MIMO (Multiple-Input Multiple-Output) technology or the like) incorporating a plurality of transmission/reception antennas is not disclosed. Hence, when the multi-antenna is used, it is impossible to improve spectrum efficiency by performing spectrum shaping including clipping on a transmission signal from a mobile station apparatus.

The present invention is made in view of the foregoing conditions; an object of the present invention is to provide a wireless control apparatus, a wireless terminal apparatus, a wireless communication system, a control program of the wireless control apparatus and the wireless terminal apparatus, and an integrated circuit that can improve, when a mobile station apparatus uses a multi-antenna, spectrum efficiency by clipping a transmission signal from the mobile station apparatus.

(1) To achieve the above object, the present invention performs the following means. Specifically, according to an embodiment of the present invention, there is provided a wireless control apparatus applied to a wireless communication system that performs clipping processing not to transmit a spectrum of part of a frequency domain to transmit and receive data, based on channel state information with a wireless terminal apparatus which is a destination, generates clipping information indicating a frequency domain where the clipping processing is performed and determines frequency allocation for the wireless terminal apparatus to generate frequency allocation information, and notifies the wireless terminal apparatus of the clipping information and the frequency allocation information.

Since as described above, the wireless control apparatus generates clipping information indicating a frequency domain where the clipping processing is performed and determines frequency allocation for the wireless terminal apparatus to generate frequency allocation information, and notifies the wireless terminal apparatus of the clipping information and the frequency allocation information, when the wireless terminal apparatus uses a multi-antenna, it is possible to perform clipping on the transmission signal from the wireless terminal apparatus and to improve spectrum efficiency.

(2) In the wireless control apparatus of an embodiment of the present invention, in the case that the wireless terminal apparatus includes a plurality of transmission antennas, the wireless control apparatus independently determines clipping information for the each transmission antenna.

Since as described above, the wireless control apparatus independently determines clipping information for the each transmission antenna, it is possible to prevent information from being lost and to enhance detection accuracy. Thus, it is possible to obtain high transmission performances.

(3) In the wireless control apparatus of an embodiment of the present invention, the clipping information includes at least one of information that indicates a clipping rate indicating a ratio of the frequency domain where the clipping processing is performed to the frequency domain where the clipping processing is not performed and information that indicates a frequency position where the clipping processing is performed.

Since as described above, the clipping information includes at least one of information that indicates a clipping rate indicating a ratio of the frequency domain where the clipping processing is performed to the frequency domain where the clipping processing is not performed and information that indicates a frequency position where the clipping processing is performed, the wireless control apparatus can perform flexible control.

(4) In the wireless control apparatus of an embodiment of the present invention, the clipping information for the each transmission antenna is determined based on a gain of a channel corresponding to the each antenna.

Since as described above, the clipping information in each transmission antenna is determined based on a gain of a channel corresponding to each antenna, in the wireless control apparatus, as compared with a method of making a determination from a transmission diversity gain (or a beam forming gain) and a communication channel capacity, it is possible to prevent information from being lost and to enhance detection accuracy. Thus, it is possible to obtain high transmission performances.

(5) In the wireless control apparatus of an embodiment of the present invention, the gain of the channel in each transmission antenna is corrected based on a result of determination as to whether or not the clipping processing is performed on a signal in a frequency domain that is transmitted through other transmission antennas.

Since as described above, the gain of the channel in each transmission antenna is corrected based on a result of determination as to whether or not the clipping processing is performed on a signal in a frequency domain that is transmitted through another transmission antenna, in the wireless control apparatus, it is possible to prevent information from being lost and to enhance detection accuracy. Thus, it is possible to obtain a high transmission performance.

(6) In the wireless control apparatus of an embodiment of the present invention, in the case that the wireless terminal apparatus includes a plurality of transmission antennas, the wireless control apparatus determines common clipping information for the each transmission antenna.

Since as described above, in the wireless control apparatus, when the wireless terminal apparatus includes a plurality of transmission antennas, the wireless control apparatus determines common clipping information for the each transmission antenna, when the wireless terminal apparatus uses a multi-antenna, it is possible to perform clipping on the transmission signal from the wireless terminal apparatus and to improve spectrum efficiency.

(7) In the wireless control apparatus of an embodiment of the present invention, the clipping information includes at least one of information that indicates a clipping rate indicating a ratio of the frequency domain where the clipping processing is performed to the frequency domain where the clipping processing is not performed and information that indicates a frequency position where the clipping processing is performed.

Since as described above, the clipping information includes at least one of information that indicates a clipping rate indicating a ratio of the frequency domain where the clipping processing is performed to the frequency domain where the clipping processing is not performed and information that indicates a frequency position where the clipping processing is performed, the wireless control apparatus can perform flexible control.

(8) In the wireless control apparatus of an embodiment of the present invention, the clipping information is determined based on a communication channel capacity of the wireless terminal apparatus.

Since as described above, the clipping information is determined based on a communication channel capacity of the wireless terminal apparatus, in the wireless control apparatus, when the wireless terminal apparatus uses a multi-antenna, it is possible to perform clipping on the transmission signal from the wireless terminal apparatus and to improve spectrum efficiency.

(9) According to an embodiment of the present invention, there is provided a wireless terminal apparatus applied to a wireless communication system that performs clipping processing not to transmit a spectrum of part of a frequency domain so as to transmit and receive data, receives clipping information indicating a frequency domain where the clipping processing is performed and frequency allocation information indicating frequency allocation from a wireless control apparatus with which to communicate, based on the received clipping information and frequency allocation information, performs the clipping processing on the frequency domain, and converts a frequency signal on which the clipping processing is performed into a signal in a time domain to transmit to the wireless control apparatus.

Since as described above, in the wireless terminal apparatus, based on the received clipping information and frequency allocation information, performs the clipping processing on the frequency domain, in the wireless control apparatus, when the wireless terminal apparatus uses a multi-antenna, it is possible to perform clipping on the transmission signal from the wireless terminal apparatus and to improve spectrum efficiency.

(10) The wireless communication system of an embodiment of the present invention includes the wireless control apparatus of any one of (1) to (8) described above and the wireless terminal apparatus of (9) described above.

Since as described above, the wireless communication system of the present invention includes the wireless control apparatus of any one of (1) to (8) described above and the wireless terminal apparatus of (9) described above, when the wireless terminal apparatus uses a multi-antenna, it is possible to perform clipping on the transmission signal from the wireless terminal apparatus and to improve spectrum efficiency.

(11) According to an embodiment of the present invention, there is provided a control program of a wireless control apparatus applied to a wireless communication system that performs clipping processing not to transmit a spectrum of part of a frequency domain so as to transmit and receive data, where the control program makes a computer execute sequential processing, and the processing includes: processing, based on channel state information with a wireless terminal apparatus which is a destination, to generate clipping information indicating a frequency domain where the clipping processing is performed; processing to determine frequency allocation for the wireless terminal apparatus so as to generate frequency allocation information; and processing to notify the wireless terminal apparatus of the clipping information and the frequency allocation information.

Since as described above, in the wireless control apparatus notifies the wireless terminal apparatus of the clipping information and the frequency allocation, when the wireless terminal apparatus uses a multi-antenna, it is possible to perform clipping on the transmission signal from the wireless terminal apparatus and to improve spectrum efficiency.

(12) According to an embodiment of the present invention, there is provided a control program of a wireless terminal apparatus applied to a wireless communication system that performs clipping processing not to transmit a spectrum of part of a frequency domain so as to transmit and receive data, where the control program makes a computer execute sequential processing, and the processing includes: processing to receive clipping information indicating a frequency domain where the clipping processing is performed and frequency allocation information indicating frequency allocation from a wireless control apparatus which is a destination; processing to perform the clipping processing on the frequency domain based on the received clipping information and frequency allocation information; and processing to convert a frequency signal on which the clipping processing is performed into a signal in a time domain to transmit to the wireless control apparatus.

Since as described above, the wireless terminal apparatus performs the clipping processing on the frequency domain based on the received clipping information and frequency allocation information, when the wireless terminal apparatus uses a multi-antenna, it is possible to perform clipping on the transmission signal from the wireless terminal apparatus and to improve spectrum efficiency.

(13) According to an embodiment of the present invention, there is provided an integrated circuit that is implemented in a wireless control apparatus to make the wireless control apparatus perform a plurality of functions, and the functions includes: a function, based on channel state information with a wireless terminal apparatus which is a destination, to generate clipping information indicating a frequency domain where the clipping processing is performed; a function to generate frequency allocation for the wireless terminal apparatus to generate frequency allocation information; and a function to notify the wireless terminal apparatus of the clipping information and the frequency allocation information.

Since as described above, the wireless control apparatus notifies the wireless terminal apparatus of the clipping information and the frequency allocation information, when a first communication apparatus uses a multi-antenna, it is possible to perform clipping on the transmission signal from the first communication apparatus and to improve spectrum efficiency.

(14) According to an embodiment of the present invention, there is provided an integrated circuit that is implemented in a wireless terminal apparatus to make the wireless terminal apparatus perform a plurality of functions, and the functions includes: a function to receive clipping information indicating a frequency domain where the clipping processing is performed and frequency allocation information indicating frequency allocation from a wireless control apparatus which is a destination; a function to perform the clipping processing on the frequency domain based on the received clipping information and frequency allocation information; and a function to convert a frequency signal on which the clipping processing is performed into a signal in a time domain to transmit to the wireless control apparatus

Since as described above, the wireless terminal apparatus performs the clipping processing on the frequency domain based on the received clipping information and frequency allocation information, when the wireless terminal apparatus uses a multi-antenna, it is possible to perform clipping on the transmission signal from the wireless terminal apparatus and to improve spectrum efficiency.

According to the present invention, it is possible to apply the spectrum shaping to the multi-antenna technology. In this way, the base station apparatus can improve, when the mobile station apparatus uses the multi-antenna, the spectrum efficiency by clipping the transmission signal from the mobile station apparatus.

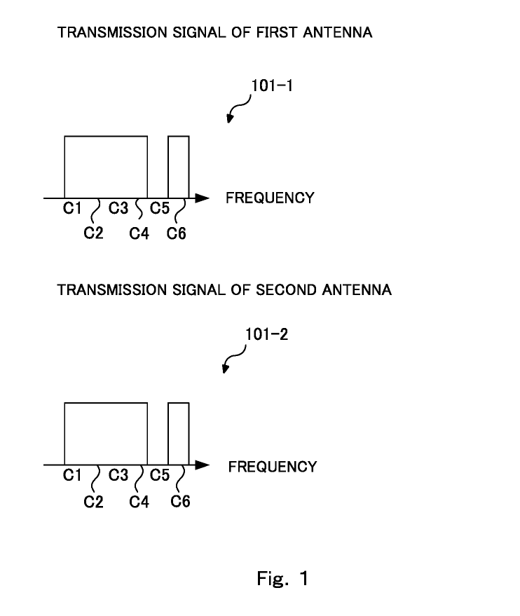

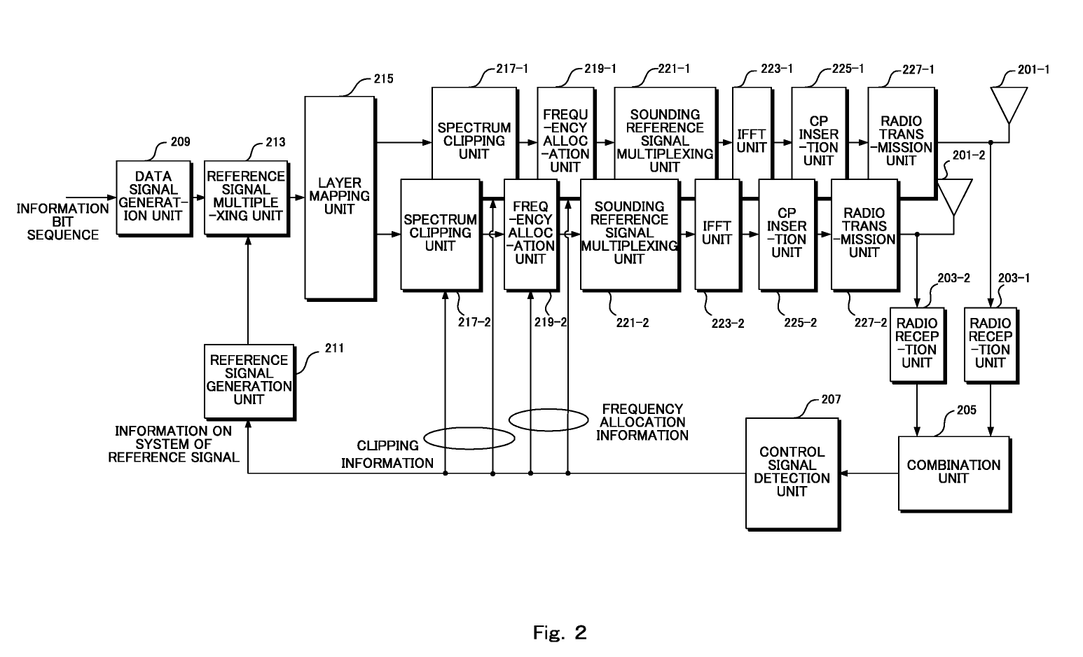

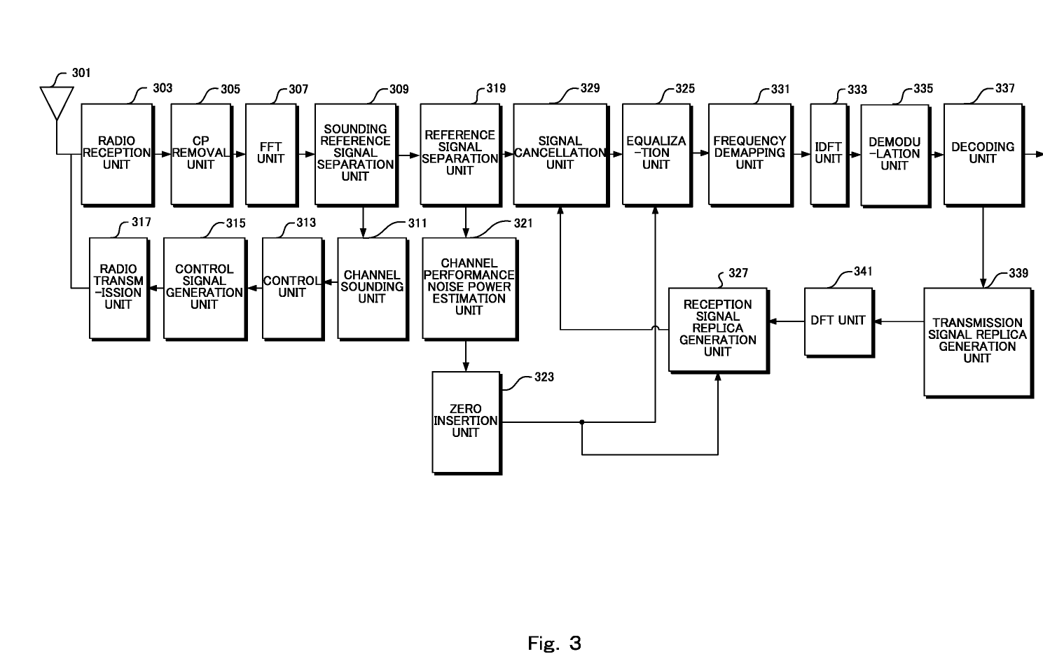

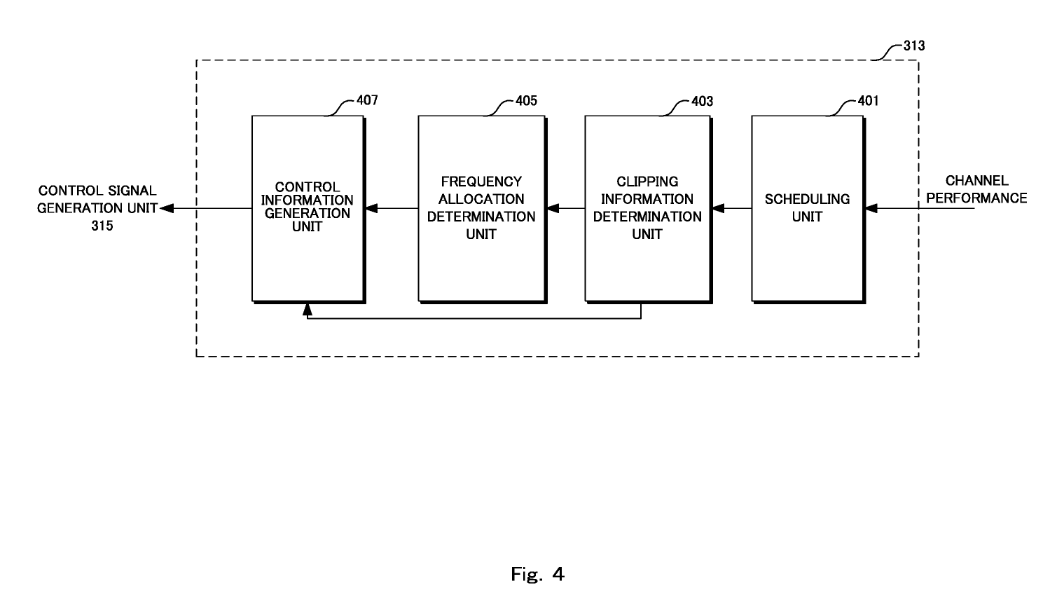

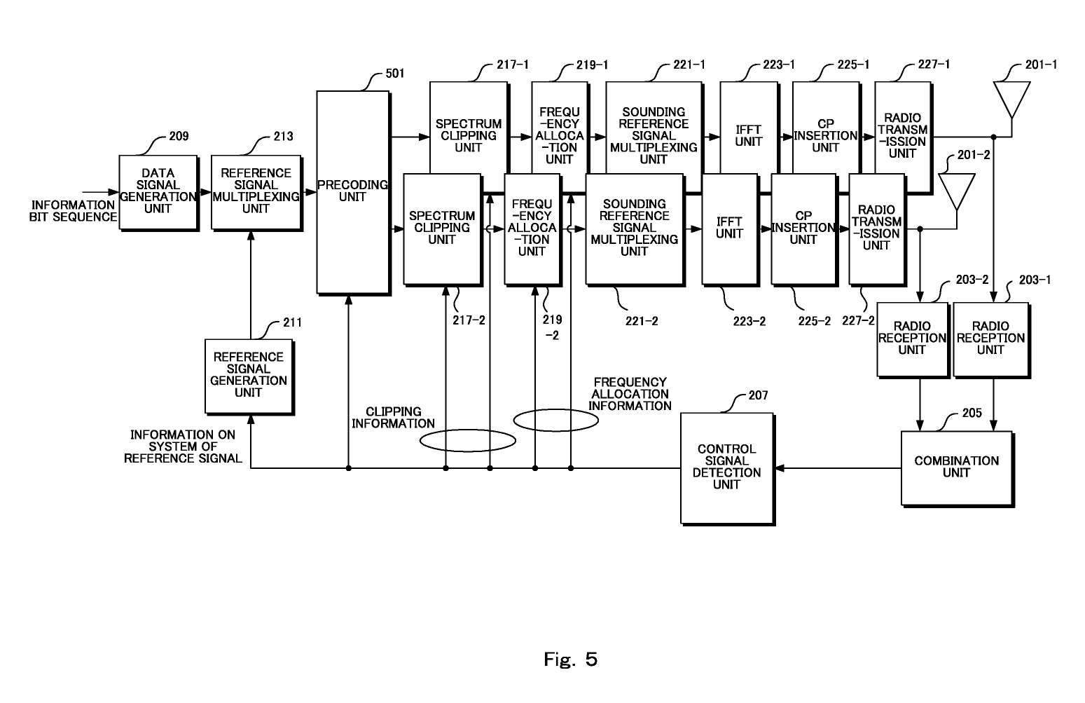

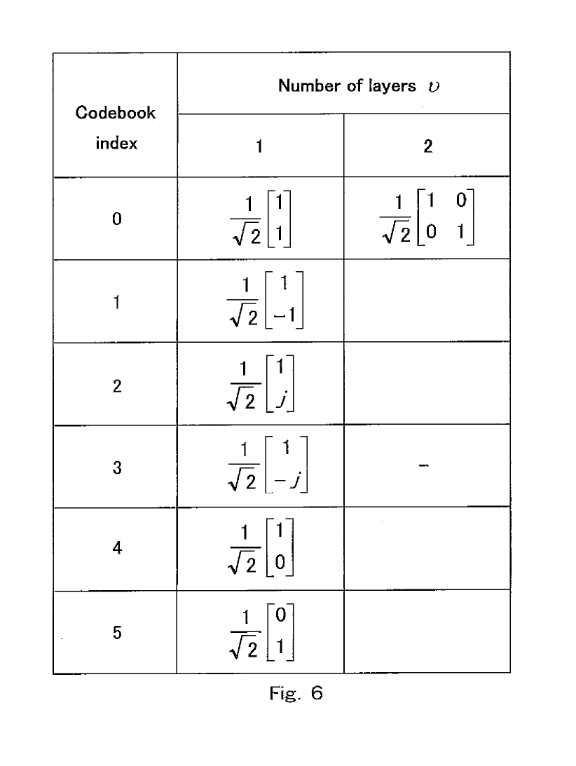

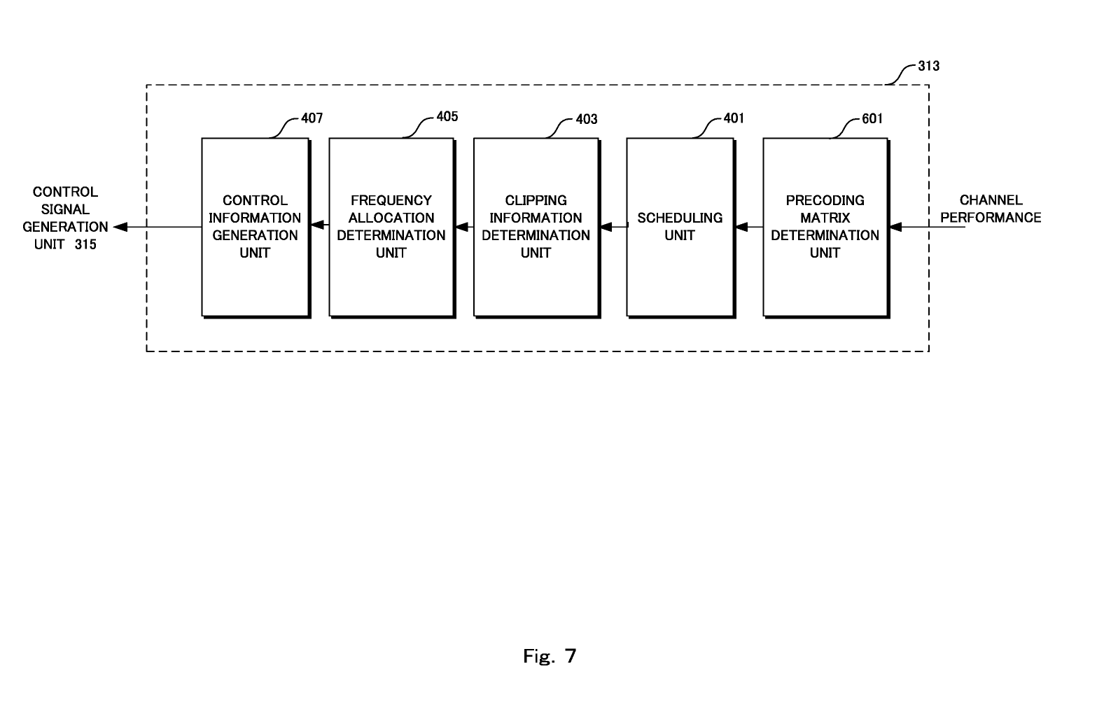

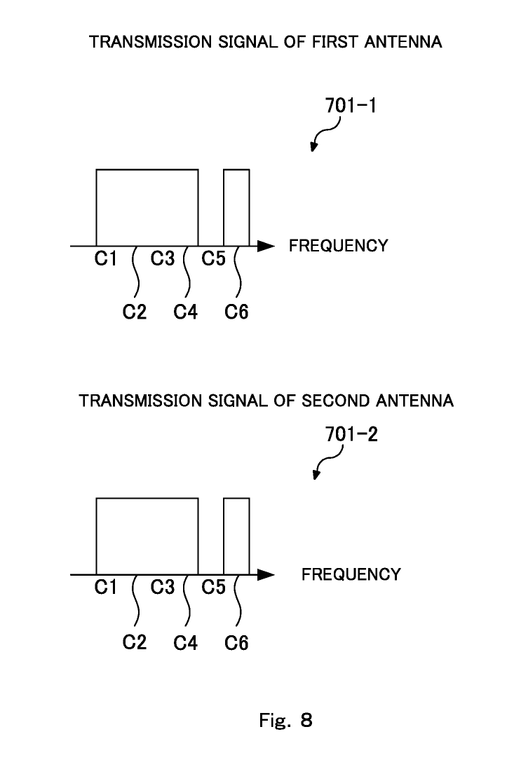

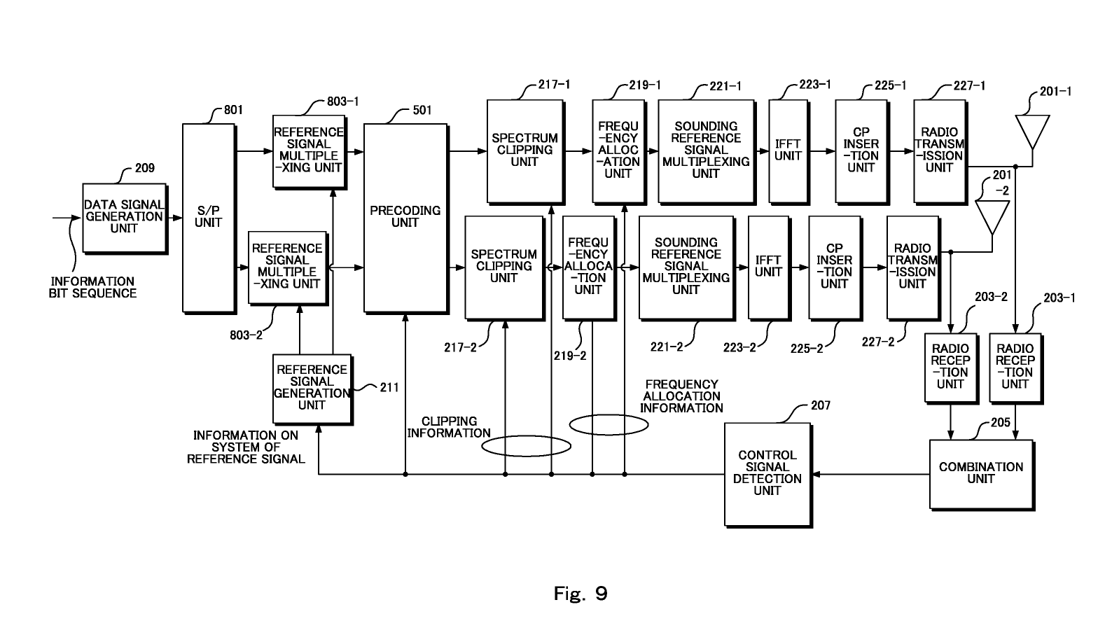

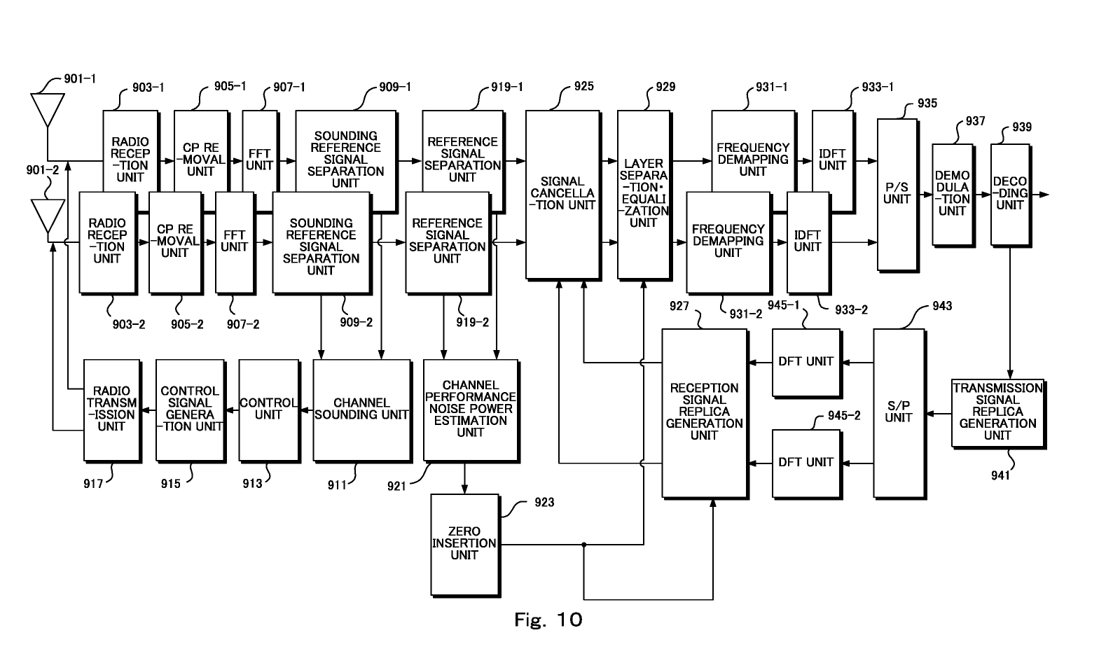

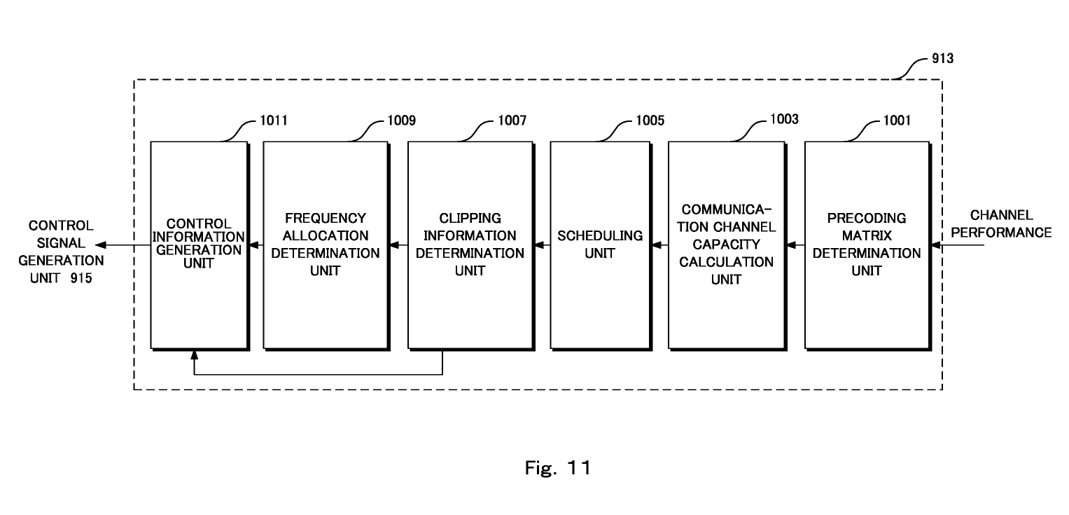

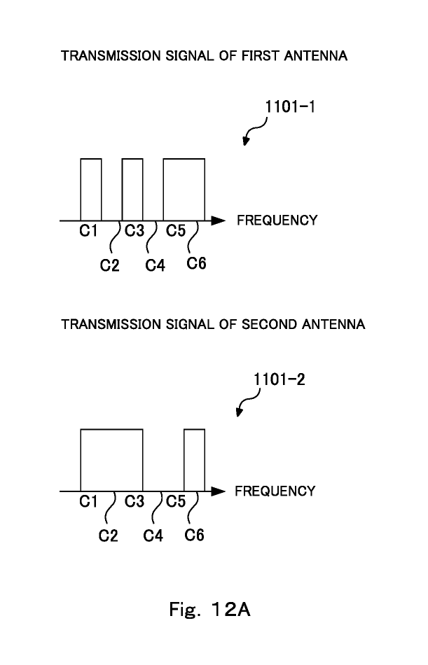

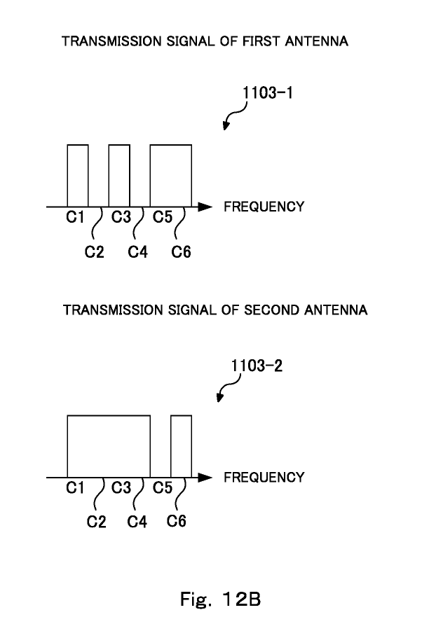

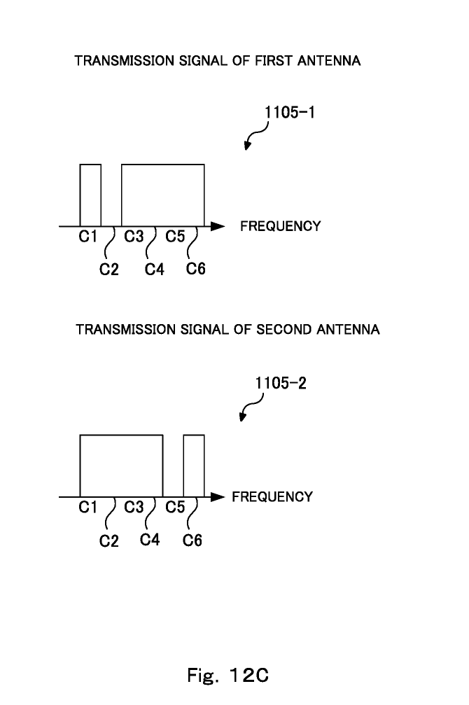

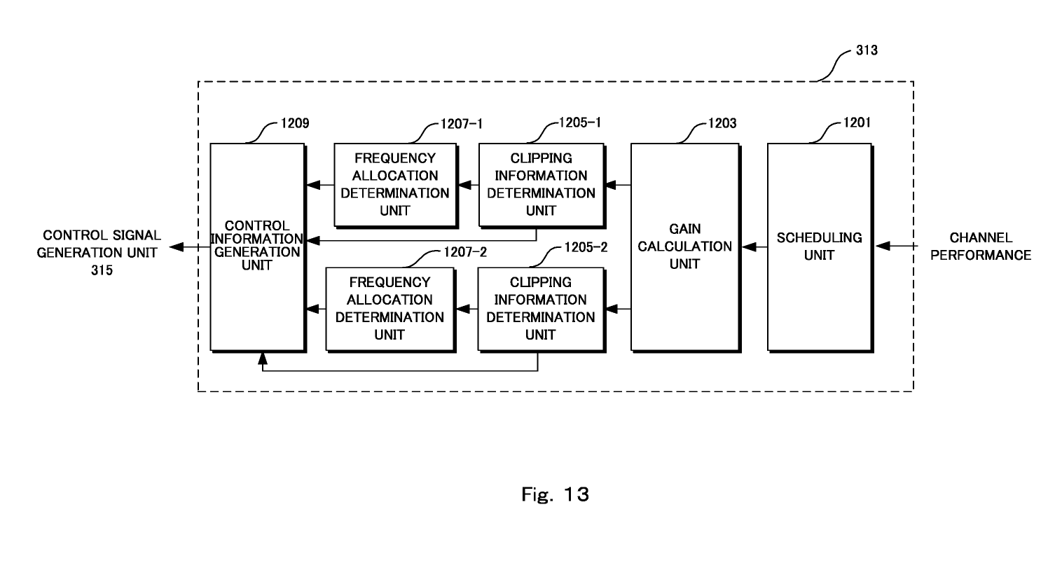

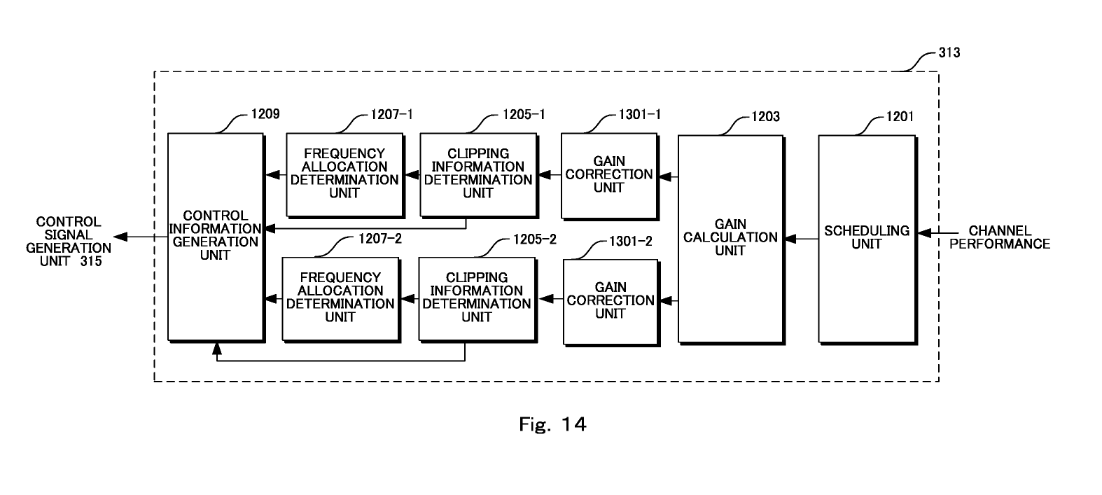

### BRIEF DESCRIPTION OF THE DRAWINGS

[FIG. 1] A diagram showing the concept of a case where a multi-antenna technology is applied to a spectrum clipping technology in a first embodiment of the present invention;

[FIG. 2] A block diagram showing an example of a basic configuration of a mobile station apparatus according to the first embodiment of the present invention;

[FIG. 3] A block diagram showing the configuration of a base station apparatus according to the first embodiment of the present invention;

[FIG. 4] A block diagram showing an example of a control unit 313 according to the first embodiment of the present invention;

[FIG. 5] A block diagram showing an example of a mobile station apparatus according to a second embodiment of the present invention;

[FIG. 6] A table showing a precoding matrix in LTE-A;

[FIG. 7] A block diagram showing an example of a control unit 313 according to the second embodiment of the present invention;

[FIG. 8] A diagram showing an example of a concept of a frequency signal of each transmission antenna in MIMO in a third embodiment of the present invention;

[FIG. 9] A block diagram showing an example of a mobile station apparatus according to the third embodiment of the present invention;

[FIG. 10] A block diagram showing an example of a base station apparatus according to the third embodiment of the present invention;

[FIG. 11] A block diagram showing an example of the configuration of a control unit 913 according to the third embodiment of the present invention;

[FIG. 12A] A diagram showing a case where a signal from each transmission antenna is independently set in a fourth embodiment of the present invention;

[FIG. 12B] A diagram showing a case where a signal from at least one side antennas is allocated in any frequency in the fourth embodiment of the present invention;

[FIG. 12C] A diagram showing a case where a clipping rate is limited and a signal is allocated to at least one side frequency in the fourth embodiment of the present invention;

[FIG. 13] A block diagram showing an example of a configuration of a control unit 313 according to a fourth embodiment of the present invention;

[FIG. 14] A block diagram showing an example of a configuration of a control unit 313 according to the fourth embodiment of the present invention; and

[FIG. 15] A diagram showing a concept of spectrum clipping disclosed in non-patent document 1.

### BEST MODES FOR CARRYING OUT THE INVENTION

Embodiments of the present invention will be described below with reference to accompanying drawings. In the following embodiments, clipping processing included in spectrum shaping is targeted, and, although power distribution on a frequency signal (a frequency signal which is not clipped) to be transmitted is not particularly described, a case where spectrum shaping including processing performing power distribution is performed is included in the present invention.

### First Embodiment

### 2×1 Transmit Diversity

In the present embodiment, a method of determining, in common, a frequency to be clipped for each transmission antenna used for transmission will be described.

FIG. 1 is a diagram showing the concept of a case where a multi-antenna technology is applied to a spectrum clipping technology in the first embodiment of the present invention. In FIG. 1, it is assumed that discrete frequencies (subcarriers) allocated to a mobile station apparatus are present at 6 points, and that they are C1, C2, C3, C4, C5 and C6 in ascending order of frequency. The mobile station apparatus transmits a transmission signal 101-1 in a frequency domain from a first transmission antenna and a transmission signal 101-2 in a frequency domain from a second transmission antenna. Here, as shown in the drawing, each transmission antenna is assumed to perform the same clipping. Here, the spectrum having the signals allocated is C1, C2, C3, C4 and C6, and C5 is clipped. The signal arranged in each transmission antenna is the same. When it is assumed that the number of antennas used for transmission is 2, and the number of antennas used for reception in the base station apparatus is 1, a reception signal at a kth discrete frequency is expressed by formula (1) below.

$$\begin{matrix}[ Formula 1 ] & \\ \begin{matrix}R ( k ) = \frac{1}{\sqrt{2 }} {H}_{1} ( k ) S ( k ) + \frac{1}{\sqrt{2 }} {H}_{2} ( k ) S ( k ) + η ( k ) \\ = ( {H}_{1} ( k ) + {H}_{2} ( k ) ) S ( k ) + η ( k )\end{matrix} & \end{matrix}$$

In formula (1), S(k) is a transmission signal that is represented by a complex number at the kth discrete frequency, R(k) is a reception signal that is represented by a complex number at the kth discrete frequency, H₁(k) is a channel performance that is represented by a complex number between the first antenna of the mobile station apparatus and the antenna of the base station apparatus, H₂(k) is a channel performance that is represented by a complex number between the second antenna of the mobile station apparatus and the antenna of the base station apparatus, and η(k) is a noise that is represented by a complex number including interference or the like from an adjacent cell. 1/√2 is a value for performing normalization such that the total of transmit power from all transmission antennas is constant. In this case, it is found from formula (1) that a channel performance equivalent to the transmission signal is H₁(k)+H₂(k). Hence, the equivalent channel performance is used to determine clipping information and frequency allocation information. When the reception signal is expressed as in formula (1), the power gain G(k) of the transmission signal is expressed by formula (2).

$$\begin{matrix}[ Formula ( 2 ) ] & \\ G ( k ) = \frac{1}{2} {\vert {H}_{1} ( k ) + {H}_{2} ( k ) \vert}^{2} & \end{matrix}$$

Based on formula (2), the clipping information to be transmitted is determined. First, for all discrete frequencies included in a system band, formula (2) is calculated. Thereafter, frequency allocation and a clipping rate expressed in formula (2) are determined. For example, for the frequency allocation, allocation such as Proportional Fairness (PF), Max CIR (Carrier to Interference power Ratio, which may be also referred to as MaxSINR, MaxSNR or the like) and Round Robin (RR) that are commonly utilized when the entire system band is shared by a plurality of mobile station apparatuses may be used.

For the clipping rate, in a case where a clipping rate is implicitly defined based on a method of preventing allocation among allocated frequencies when the value of formula (2) is a given threshold value or less, a clipping rate previously defined in the system or a combination of a modulation scheme and a coding rate (which may be also referred to as MCS (Modulation and Coding Scheme), the previously defined clipping rate may be used. For example, in the case of QPSK where the coding rate is 1/2, the clipping rate is assumed to be defined to be 20%. First, the allocation frequency of the mobile station apparatus is determined by an allocation method such as PF, then formula (2) is removed, with the allocated frequency, from the allocation frequency by only 20% in ascending order and it is determined as the final allocation frequency. A frequency position to be clipped or the like may be used. In a method of using the water filling theorem disclosed in non-patent document 1, information on the distribution of the transmit power may be further notified; the same is true for any embodiment disclosed in the present invention.

FIG. 2 is a block diagram showing an example of a basic configuration of a mobile station apparatus according to the first embodiment of the present invention. A description will be given on the assumption that the number of transmission/reception antennas of the mobile station apparatus is 2. The number of transmission/reception antennas of the mobile station apparatus is naturally not limited. Here, a description will be given on the assumption that the number of streams to be spatially transmitted is one. First, in the mobile station apparatus, a control signal notified from the base station apparatus in a downlink is received by antennas 201-1 and 201-2 (the antennas 201-1 and 201-2 are combined and represented by an antenna 201), radio reception apparatuses 203-1 and 203-2 down-convert it into a baseband signal and the baseband signal is subjected to A/D (Analog to Digital) conversion. The combination of the reception signals such as maximum ratio combining is performed on the obtained digital signal by a combination unit 205. Then, for the combined reception signal, a control signal detection unit 207 detects information on the system of a reference signal, information on the clipping rate, frequency allocation information and the like.

For an information bit sequence to be transmitted, a data signal generation unit 209 generates the frequency signal of data to be transmitted. In the data signal generation unit 209, the information bit sequence is subjected to error correction coding to generate a modulation symbol such as QPSK (Quaternary Phase Shift Keying) or 16QAM (16-ary Quadrature Amplitude Modulation) and is converted into a frequency signal by DFT (Discrete Fourier Transform). Then, based on the information on the reference signal, a Reference Signal (RS) for channel estimation of each transmission antenna is generated by a reference signal generation unit 211, and is multiplexed with a data signal in a reference signal multiplexing unit 213. In a layer mapping unit 215, the signal is allocated to each antenna 201. Here, if the number of the signal (rank number) to be multiplexed is 1, copying is performed on each antenna 201 as it is whereas, if the rank number is 2, different transmission signals are allocated to each antenna 201 using a method such as S/P (Serial to Parallel) conversion or block interleave. In the present embodiment, since the same signal is assumed to be transmitted from two antennas 201, the transmission is performed in rank 1.

Then, in spectrum clipping units 217-1 and 217-2, part of the frequency signal is clipped (deleted) according to the clipping information of each antenna 201 notified. The clipping information may be frequency position information to be clipped or the clipping rate (for example, 10%). At the time of notification, a combination of the modulation scheme and the coding rate (MCS: Modulation and Coding Schemes) and the clipping rate are made to have a one-to-one correspondence, and thus notification may be implicitly provided. In this case, it is possible to determine the notified clipping information from the MCS. Thereafter, in frequency allocation units 219-1 and 219-2, the frequency signal on which the clipping has been performed in each antenna 201 is arranged at a frequency based on notified frequency allocation information. Then, in sounding reference signal multiplexing units 221-1 and 221-2, sounding reference signals for grasping the channel performance from each antenna 201 to an antenna 301 are multiplexed, and are converted into a signal of a time domain in IFFT (Inverse Fast Fourier Transform) units 223-1 and 223-2. The transmission signal converted into the time domain has a CP inserted in CP (Cyclic Prefix) insertion units 225-1 and 225-2, is subjected to D/A (Digital to Analog) conversion in radio transmission units 227-1 and 227-2, is up-converted into a radio frequency and is transmitted from antennas 201-1 and 201-2.

FIG. 3 is a block diagram showing a configuration of the base station apparatus according to the first embodiment of the present invention. Here, a case where the number of antennas is assumed to be 1 is shown as an example. The reception signal received in the antenna 301 is received in a radio reception unit 303, and the CP is removed from the reception signal in a CP removal unit 305. The reception signal is converted into a frequency signal by a FFT unit 307. The reception signal converted into the frequency signal first has the sounding reference signal separated in a sounding reference signal separation unit 309. In the separated sounding reference signal, a reception state (for example, reception SINR) from each antenna 201 to the antenna 301 is estimated in a channel sounding unit 311, and the estimated reception state and the estimated channel performance are input to a control unit 313. In the control unit 313, the clipping information and the frequency allocation of each antenna 201 are determined. The determined control information is converted into a control signal by a control signal generation unit 315, is subjected to D/A conversion by a radio transmission unit 317, is up-converted and is transmitted from the antenna 301.

Then, in the reception signal having the sounding reference signal separated, the reference signal is removed from the reception signal by a reference signal separation unit 319. In the removed reference signal, noise power including the channel performance from each antenna 201 and interference from the adjacent cell is estimated by a channel performance•noise power estimation unit 321. Thereafter, in the channel performance estimated by the channel performance•noise power estimation unit 321, zero is inserted into the clipped frequency by a zero insertion unit 323 on the side of the mobile station apparatus, and thus an equivalent channel is calculated. The obtained equivalent channel is input to an equalization unit 325 and a reception signal replica generation unit 327.

Then, in the reception signal output from the reference signal separation unit 319, a reception signal replica input from the reception signal replica generation unit 327 is cancelled in a signal cancellation unit 329. However, at the first time of the repetition, nothing is cancelled. Then, the reception signal is equalized in the equalization unit 325, and a desired signal is extracted in a frequency domain from a frequency allocated by a frequency demapping unit 331. Thereafter, the desired signal is converted into a time signal by an IDFT (Inverse Discrete Fourier Transform) unit 333, and a Log likelihood Ration (LLR) is obtained from a demodulation unit 335. Then, error correction processing is performed in a decoding unit 337. Here, the decoding unit 337 outputs the LLR of an information bit and the LLR of a coding bit.

The LLR of the information bit is input to a transmission signal replica generation unit 339, and a soft replica (soft estimation) of the transmission signal is generated. Thereafter, the soft estimation is input to a DFT unit 341, and is converted into a frequency signal. In this example, since transmission is performed by two antennas 201 and reception is performed by one antenna 301, two identical (copied) soft replicas are output. Then, the soft replicas are converted into a soft replica in a frequency domain by the DFT unit 341. In the reception signal replica generation unit 327, by multiplying the soft replica by the equivalent channel output from the zero insertion unit 323A, a reception signal replica is calculated. The reception signal replica is input to the signal cancellation unit 329, and the processing described above is repeated. This is repeated arbitrary number of times, the LLR of the information bit output from the decoding unit 337 is subjected to hard determination and thus a decoding bit sequence is obtained. Then, the control unit 313 will be described.

FIG. 4 is a block diagram showing an example of the control unit 313 according to the first embodiment of the present invention. In the control unit 313, the frequency allocation is determined from the estimated channel performance by formula (2) through a scheduling unit 401. Thereafter, the clipping information is generated by a clipping information determination unit 403 per antenna 201, and the final frequency allocation is determined in a frequency allocation determination unit 405. In the clipping information and the frequency allocation obtained in this way, control information is generated by a control information generation unit 407, and is input to the control signal generation unit 315. In the control signal generation unit 315, by a method set according to the system, a control signal for multiplexing, modulation or the like is generated, and is input to the radio transmission unit 317. As described above, in the present embodiment, based on the complexed equivalent channel in the application to a multi-antenna, the clipping information and the frequency allocation are determined, and thus the clipping can also be applied to the multi-antenna technology.

### Second Embodiment

### In a Case where Precoding is Performed

In the present embodiment, a case where beam forming called precoding is applied will be described.

FIG. 5 is a block diagram showing an example of a mobile station apparatus according to the second embodiment of the present invention. As compared with FIG. 2, the layer mapping unit 215 is changed to a precoding unit 501. In the precoding unit 501, a previously defined precoding matrix is multiplied.

FIG. 6 is a table showing the precoding matrix in LTE-A. Here, a case where the number of transmission antennas is 2 is shown as an example. “Number of layers u” is a layer number, and, when the layer number is 1, two antennas 201 are used to transmit signals of one stream whereas when the layer number is 2, signals of two streams are transmitted. “Codebook index” is an index when which matrix is used for the mobile station apparatus is notified. Here, since rank 2 is described in an embodiment, which will be described later, a description will be given here on the assumption that the precoding matrix of rank 1 is used. Since in rank 1, transmission signals of one stream are transmitted by multiplying a precoding matrix w shown in FIG. 6, a reception signal at the kth frequency is expressed by formula (3).

R(k)=h(k)wS(k)+η(k) [symbol] [Formula 3]

In formula (3), S(k) is the amplitude of a transmission signal that is represented by a complex number at the kth frequency domain, η(k) is a noise containing interference from the adjacent cell, R(k) is the amplitude of a reception signal and w is any one matrix selected from the precoding matrix of the layer number 1 shown in FIG. 6. Moreover, h(k) is a channel matrix represented by 1×2, and is expressed by formula (4).

h(k)=[h₁(k),h₂(k)] [symbol] [Formula 4]

However, h₁(k) is a channel performance that is represented by a complex number at the kth frequency from the first antenna 201-1 to the antenna 301, and h₂(k) is a channel performance that is represented by a complex number at the kth frequency from the second antenna 201-2 to the antenna 301. Hence, a power gain at the kth frequency represented as described above is expressed by formula (5)

P(k)=|h(k)w|² [symbol] [Formula 5]

In formula (5), P(k) is a power gain for a transmission signal that is represented by a real number at the kth frequency. Based on formula (5), the same method as in the first embodiment is used to determine clipping frequency and the frequency allocation. Since the configuration of the reception apparatus (base station apparatus) is the same as in FIG. 3, its description will be omitted. As described above, even when the precoding is applied, the present invention can be applied. Here, since, for simplicity, the description has been given on the assumption that the number of reception antennas is 1, if the number of antennas for reception is two or more, a reception diversity technology such as the Maximum Ratio Combining (MRC) is preferably used to perform the reception, and the number of reception antennas is not limited. On the transmission of the control information, when the number of antennas 201 is two or more, a transmission diversity technology such as Space Time Coding (STC), STBC (Space Time Block Code), SFBC (Space Frequency Block Code), Cyclic Delay Diversity (CDD), Time Switching Transmit Diversity (TSTD), Frequency Switching Diversity (FSTD) or antenna selection diversity may be used or a method of constantly performing reception from any antenna 201 may be used.

FIG. 7 is a block diagram showing an example of the control unit 313 according to the second embodiment of the present invention. The basic configuration is the same as in FIG. 4; a precoding matrix determination unit 601 is newly added. The precoding matrix determination unit 601 selects the optimum precoding matrix based on a spatial correlation output from the channel sounding unit 311 from each antenna 201 to the antenna 301 or the like and the channel state of the channel performance. Based on the selected precoding matrix, scheduling is performed in the scheduling unit 401. Even when precoding is used in this way, the present invention can be applied.

### Third Embodiment

### In the Case of MIMO

In the present embodiment, a case of MIMO will be described. Here, a case where two antennas 201 are used to perform transmission in rank 2 will be described.

FIG. 8 is a diagram showing an example of the concept of a frequency signal of each antenna in MIMO in a third embodiment of the present invention. FIG. 8 differs from FIG. 1 in that a transmission signal 701-1 and a transmission signal 701-2 are different signals.

FIG. 9 is a block diagram showing an example of a mobile station apparatus according to the third embodiment of the present invention. Here, a case where the number of information bit sequences called a code word is 1 will be described. In this case, in order to transmit two streams, an S/P (Serial to Parallel) unit 801 performs serial-to-parallel conversion. Then, in reference signal multiplexing units 803-1 and 803-2, reference signals for demodulation of each stream are multiplexed. Since the reference signals need to be separated in the reception apparatus (base station apparatus), different symbols such as an orthogonal code or cyclic shift are allocated. Thereafter, in the precoding unit 501, based on the notified precoding information, the precoding matrix of rank 2 is multiplied. In the case of FIG. 6, a matrix where υ is 2 (in the drawing, a matrix obtained by increasing a unit matrix by a factor of 1/√2) is selected. However, in other mobile communication system, when other matrix of rank 2 is defined, it can be selected.

FIG. 10 is a block diagram showing an example of the base station apparatus according to the third embodiment of the present invention. Here, a configuration in which the number of antennas in the base station apparatus is 2, the number of code words is 1 and the signal of rank 2 is detected is shown as an example. A signal received in antennas 901-1 and 901-2 (the antennas 901-1 and 901-2 are combined and represented by an antenna 901) is down-converted into a baseband signal in radio reception unit 903-1 and 903-2, CP is removed from the reception signal in CP removal units 905-1 and 905-2, the reception signal is converted into a frequency signal in FET units 907-1 and 907-2 and a sounding reference signal is separated in sounding reference signal separation units 909-1 and 909-2. In the separated sounding reference signal, the state of the channel is estimated in a channel sounding unit 911. The estimated channel matrix can be expressed as a matrix by formula (6).

$$\begin{matrix}[ Formula 6 ] & \\ H ( k ) = [ \begin{matrix}{h}_{11} ( k ) & {h}_{12} ( k ) \\ {h}_{21} ( k ) & {h}_{22} ( k )\end{matrix} ] & \end{matrix}$$

hₙₘ(k) is a channel matrix at the kth discrete frequency between the mth antenna 201 in the mobile station apparatus and the nth antenna 901 in the base station apparatus; in general, a channel matrix is configured such that an index of each antenna 901 is an element in the column direction of the matrix and an index of each antenna 201 is an element in the row direction of the matrix. This channel matrix is input to a control unit 913.

FIG. 11 is a block diagram showing an example of the configuration of a control unit 913 according to the third embodiment of the present invention. In the channel performance input to the control unit 913, the precoding matrix is determined by a precoding matrix determination unit 1001, and is input to a communication channel capacity calculation unit 1003. In the communication channel capacity calculation unit 1003, as in formula (7), the communication channel capacity of each frequency (may be a source block unit formed by a plurality of discrete frequencies) is calculated.

$$\begin{matrix}[ Formula 7 ] & \\ C ( u ) = \frac{1}{K} {\sum }_{k ∈ u} {log}_{2} ( 1 + SINR \times det [ H ( k ) {H}^{H} ( k ) ] ) & \end{matrix}$$

where u represents an index of a resource block, k represents a discrete frequency point number included in the resource block, SINR represents a ratio of the reception signal to interference noise power and det represents a matrix formula. This represents the average communication channel capacity of each source block. Although here, the communication channel capacity based on the precise definition has been used as an example, a case where a quantitative value having a similar correlation to the communication channel capacity is used is naturally included in the present invention. Thereafter, the average communication channel capacity of each source block is input to a scheduling unit 1005, and is input to a clipping information determination unit 1007. A frequency allocation determination unit 1009 determines frequency allocation from the obtained information. In the frequency allocation information and the clipping information determined in this way, control information is generated by a control information generation unit 1011, and is input to a control signal generation unit 915.

With reference back to FIG. 10, the control signal generation unit 915 generates, from the control information output from the control unit 913, the control signal corresponding to the system. A radio transmission unit 917 converts the control signal into a radio signal. Thereafter, the radio signal is transmitted from the antennas 901-1 and 901-2. On the other hand, in the reception signal having the sounding reference signal separated, the reference signal of each layer is separated in reference signal separation units 919-1 and 919-2, and a channel performance noise power estimation unit 921 estimates the channel performance in each antenna 901 of each layer and noise power in each antenna 901. In the obtained channel performance, zero is inserted into the channel performance of the clipped frequency by a zero insertion unit 923. Thereafter, in the reception signal having the reference signal separated, a reception signal replica input from a reception signal replica generation unit 927 is subtracted by a signal cancellation unit 925. However, in the first round of processing, no cancellation is made.

Then, in the reception signal, a layer separation•equalization unit 929 uses an equivalent channel performance calculated by the zero insertion unit 923 and the noise power to perform equalization processing for the separation of the layers and the removal of distortion due to the channel from the reception signal. Then, in the reception signal, based on the allocation frequency, the signal of each layer is sequentially returned to the original discrete frequency by frequency demapping units 931-1 and 931-2. The reception signal is converted into a time signal by IDFT units 933-1 and 933-2, and is returned to the original one by a P/S (Parallel to Serial) unit 935 through the parallel-to-serial conversion of the reception signal converted into a time domain. Thereafter, a demodulation unit 937 calculates the LLR of a code bit, and a decoding unit 939 performs error correction.

In the LLR of the code bit obtained from the decoding unit 939, a transmission signal replica generation unit 941 calculates the soft estimation (also referred to as a soft replica) of the transmission signal, and an S/P unit 943 perform the serial-to-parallel conversion on the signal of each layer again. Then, DFT units 945-1 and 945-2 generate a soft estimation value (soft replica) in a frequency domain, and, in the reception signal replica generation unit 927, the soft estimation is multiplied by the equivalent channel performance output from the zero insertion unit 923 to generate the reception signal replica. The obtained reception signal replica is input to the signal cancellation unit 925 again. The processing described above is repeated arbitrary number of times (predetermined number of times, until no error is present), and the LLR of the information bit output from the decoding unit 939 is finally subjected to hard determination, and thus the decoding bit is obtained.

With this configuration, it is also possible to apply the clipping technology to the MIMO technology. The essence of the present invention is the processing of the control unit 913 shown in FIG. 11, that is, to determine the clipping information from the communication channel capacity. The first to third embodiments are combined by adaptation control such as rank adaptation and can be selected adaptively; these combinations are also included in the present invention.

### Fourth Embodiment

### In a Case where Different Types of Clipping are Performed in the Individual Antennas 201

As compared with a method in which, in order to determine information on the clipping and information on the frequency allocation independently for each antenna 201, as in the first to third embodiments, the same information on the clipping and information on the frequency allocation in a plurality of antennas 201 are determined from transmission diversity gain (power gain or beam forming gain) or the communication channel capacity, in the present embodiment, it is possible to obtain a high transmission performance. In FIGS. 12A to 12C, an example of a transmission signal on a frequency axis from each antenna 201 is shown. First, in FIGS. 12A to 12C, since the transmission of rank 1 is assumed here, the original spectrum of the frequency signal of each antenna 201 is completely identical (the identical transmission signal); however, the fourth embodiment differs from the first to third embodiments in that the frequency to be clipped is different.

FIG. 12A is a diagram showing a case where a signal from each antenna 201 is independently set in the fourth embodiment of the present invention. Here, the transmission signals 1101-1 and 1101-2 are clipped independently. At frequencies C1, C3 and C6, the same signal is transmitted, and, at a frequency C4, clipping is performed in both antennas 201. At frequencies C2 and C5, transmission is performed in either of the antennas 201.

FIG. 12B is a diagram showing in which frequency a signal from at least one of the antennas 201 is allocated. Unlike FIG. 12A, as shown in transmission signal 1103-2, the transmission signal is also arranged in C4. Thus, since no information is lost in the antenna 301, it is possible to enhance detection accuracy.

FIG. 12C is a diagram showing a case where the clipping rate is limited and the signal is allocated to at least one of the frequencies. Transmission signals 1105-1 and 1105-2 are each limited to a clipping rate of 1/6=16.666 . . . , that is, 16.7%, and clipping is performed at the frequency C2 and the frequency C4. As described above, in the present embodiment, the clipping rate is limited, and a different type of clipping is performed on each antenna 201 such that the signal is allocated to at least one of the frequencies.

FIG. 13 is a block diagram showing an example of the configuration of the control unit 313 according to the fourth embodiment of the present invention. Here, the transmission of rank 1 will be described as an example. Since it is assumed that a different type of clipping is performed on each antenna 201, though in rank 1, it is difficult to apply precoding but in a case where the rank number is 2 or more, the present embodiment can be applied in such as way that clipping is performed independently on each layer, with the result that whether or not a precoding technology is applied does not limit the present invention. As the configuration of the base station apparatus, the same configuration as in FIG. 3 may be used. However, the configuration of the control unit 313 is different. In FIG. 13, in the control unit 313, a scheduling unit 1201 determines an allocation frequency position within the system band, and a channel gain at the determined frequency position from each antenna 201 is calculated in a gain calculation unit 1203. In the gain calculation unit 1203, as in formula (8), the gain of the channel is calculated.

F(k)=|h₁(k)|²

F₂(k)=|h₂(k)|² [symbol] [Formula 8]

In formula (8), F₁(k) and F₂(k) respectively represent a gain at the kth frequency from the antenna 201-1 to the antenna 301, and a gain at the kth frequency from the antenna 201-2 to the antenna 301. h₁(k) and h₂(k) respectively represent a channel performance at the kth frequency from the antenna 201-1 to the antenna 301, and a channel performance at the kth frequency from the antenna 201-2 to the antenna 301. Based on this, in each of clipping information determination units 1205-1 and 1205-2, the clipping information is determined, and, in frequency allocation determination units 1207-1 and 1207-2, the allocation frequency is determined. In the frequency allocation determination units 1207-1 and 1207-2 described above, the frequency for allocating the signal after the clipping is represented. Finally, the frequency allocation information and the clipping information are input to a control information generation unit 1209, and thus the control information generation unit 1209 generates control information, and inputs the control information to the control signal generation unit 315. The present invention has a feature in which, as described above, a different type of clipping is performed on each of a plurality of transmission antennas or each of a plurality of layers (spatial multiplexing). When a plurality of reception antennas are present, a value of formula (9) is assumed to be a gain.

F₁(k)=|h₁₁(k)²+|h₂₁(k)²

F₂(k)=|h₁₂(k)²+|h₂₂(k)|² [symbol] [Formula 9]

where hₙₘ(k) represents a channel performance from an antenna (layer) 201-m to an antenna 301-n. In general, when the number of reception antennas is increased, the gain is represented by a total obtained by adding only the number of reception antennas to the square of its absolute value. An example of the configuration of the mobile station apparatus is the same as in FIG. 5 except that the frequency positions at which the spectrum clipping units 217-1 and 217-2 are clipped differ from each other.

As described above, in the present invention, the clipping information determination units 1205-1 and 1205-2 are provided according to the number of antennas 201, and the clipping information is determined independently, with the result that the transmission performance is enhanced. Naturally, since the essence of the present invention is that the clipping information is determined for each antenna 201, the scope of the present invention is not limited by the number of reception antennas. With respect to the clipping information, a frequency having a low gain may be set or a method of selecting any one of previously defined methods may be used.

A case where, as in FIG. 12B, allocation is performed with consideration given to clipping information on the other antenna 201 will now be described. Basically, a value represented by formula (10) below is used to correct the gain.

P_{T}(k)=F_{T}(k)×β [symbol] [Formula 10]

In formula (10), F_{T} (k) represents a gain estimated at the kth frequency from the Tth antenna 201 to the base station apparatus. β represents a real number that can be arbitrarily set. Here, when, in at least one antenna 201, the antenna 201 where clipping is performed at the kth frequency is present in other place, β is more than 1 whereas, when an imaginary calculation concludes that any antenna 201 is not clipped, β is 1. Based on a rule that a frequency having a low power gain in the channel is clipped, as the value of β is increased, the clipping is unlikely to be performed whereas, when β is brought close to 1, the clipping is brought close to a method of performing clipping independently. For example, when β=2, the value of P_{T}(k) is twice as great as the actual power gain in the channel, and thus this P_{T}(k) is regarded as an imaginary channel, and the frequency to be clipped again is determined. Furthermore, β is controlled, and thus it is possible to control the number of transmission antennas where clipping can be performed at the same frequency. For example, a setting is made as in formula (11). β may be set for each discrete frequency (subcarrier) or may be set equal value to each other in all subcarriers.

P_{T}(k)=F_{T}(k)×βⁿ^{ₜ} [symbol] [Formula 11]

In formula (11), nₜ is the number of transmission antennas where clipping is performed at the kth frequency. It is possible to make such a setting. This type of method can be considered as an example. Furthermore, although the description has been given of the frequency at which, when β is 1, it is not determined that clipping is imaginarily performed, when a method of realizing the same concept is used, β does not need to be 1.

FIG. 14 is a block diagram showing an example of the configuration of the control unit 313 according to the fourth embodiment of the present invention. When in gain correction units 1301-1 and 1301-2, clipping is expected to be performed in any one of the antennas 201, the gain of each antenna 201 output from the gain calculation unit 1203 is multiplied by β whereas, when it is determined that clipping is not performed, no processing is performed. In this way, it is possible to realize the allocation as shown in FIG. 12B.

Furthermore, as the method of limiting the clipping rate as in FIG. 12C, various methods may be used such as a method of limiting the clipping rate based on the amount of Inter-Symbol Interference (ISI) produced by clipping, EXIT (Extrinsic Information Transfer) analysis, a mutual information amount and the like. The essence of the present invention is a method of setting such that the frequencies to be clipped differ between the antennas 201 or between the layers when a plurality of signals are spatially multiplexed; means for realizing such a method is all included in the present invention. Naturally, the number of transmission/reception antennas is not limited. Moreover, these may be applied to multi-carrier transmission such as OFDM. Although the first to fourth embodiments have shown aspects performed by the control unit of the base station apparatus, since it can be naturally performed by the mobile station apparatus, such a case is also included in the present invention. With respect to the clipping rate, although in the present embodiment, the clipping rate is the most suitable control, as long as the frequency allocation and the frequency to be clipped are uniquely determined such as by the frequency position where the clipping is performed, the determination may be made in any method or may be notified in any notification method.

Programs executed in the mobile station apparatus and the base station apparatus of the present invention are programs (programs that make a computer function) that control a CPU and the like so as to realize the functions of the above embodiments on the present invention. Information dealt with in these apparatuses is temporarily stored in a RAM when it is processed, is thereafter stored in various ROMs and HDDs and is read, modified and written, as necessary, by the CUP. A recording medium storing the programs may be a semiconductor medium (for example, a ROM or a nonvolatile memory card, etc.), an optical recording medium (for example, a DVD, a MO, a MD, a CD or a BD, etc.), a magnetic recording medium (for example, a magnetic tape or a flexible disc, etc.) or the like. The programs loaded are executed, and thus the functions of the above embodiments are realized; moreover, based on instructions of the program, processing is performed along with the operating system, other application program or the like, and thus the functions of the present invention may be realized.

When the programs are distributed in the market, the programs can be stored in a portable recording medium and be distributed or can be transferred to a server computer connected through a network such as the Internet. In this case, a storage apparatus in the server computer is also included in the present invention. Part or all of the mobile station apparatus and the base station apparatus in the embodiments described above may be typically realized as an LSI, which is an integrated circuit. Each functional block of the mobile station apparatus and the base station apparatus may be individually formed into a chip; part or all of them may be integrated and formed into a chip. A method of formation into an integrated circuit is not limited to an LSI; it may be realized by a dedicated circuit or a general-purpose processor. If advancement of semiconductor technology produces a technology for formation into an integrated circuit as a replacement for an LSI, the integrated circuit by such a technology can be used. Although the embodiments of this invention have been described above in detail with reference to the drawings, the specific configuration is not limited to the embodiments, and designs and the like without departing from the spirit of this invention are also included in the scope of claims. The present invention is suitable for use in a mobile communication system having a mobile telephone apparatus as a mobile station apparatus; however, the present invention is not limited to this application.

### DESCRIPTION OF SYMBOLS

1 original single carrier spectrum
3 transmission signal
5 reception signal
7 estimation signal
101-1, 101-2 transmission signal
201-1, 201-2, 201 antenna
203-1, 203-2 radio reception apparatus
205 combination unit
207 control signal detection unit
209 data signal generation unit
211 reference signal generation unit
213 reference signal multiplexing unit
215 layer mapping unit
217-1, 217-2 spectrum clipping unit
219-1, 219-2 frequency allocation unit
221-1, 221-2 sounding reference signal multiplexing unit
223-1, 223-2 IFFT unit
225-1, 225-2 CP insertion unit
227-1, 227-2 radio transmission unit
301 antenna
303 radio reception unit
305 CP removal unit
307 FFT unit
309 sounding reference signal separation unit
311 channel sounding unit
313 control unit
315 control signal generation unit
317 radio transmission unit
319 reference signal separation unit
321 channel performance•noise power estimation unit
323 zero insertion unit
325 equalization unit
327 reception signal replica generation unit
329 signal cancellation unit
331 frequency demapping unit
333 IDFT unit
335 demodulation unit
337 decoding unit
339 transmission signal replica generation unit
341 DFT unit
401 scheduling unit
403 clipping information determination unit
405 frequency allocation determination unit
407 control information generation unit
501 precoding unit
601 precoding matrix determination unit
701-1, 701-2 transmission signal
801 S/P unit
803-1, 803-2 reference signal multiplexing unit
901-1, 901-2, 901 antenna
903-1, 903-2 radio reception unit
905-1, 905-2 CP removal unit
907-1, 907-2 FFT unit
909-1, 909-2 sounding reference signal separation unit
911 channel sounding unit
913 control unit
915 control signal generation unit
917 radio transmission unit
919-1, 919-2 reference signal separation unit
921 channel performance•noise power estimation unit
923 zero insertion unit
925 signal cancellation unit
927 reception signal replica generation unit
929 layer separation•equalization unit
931-1, 931-2 frequency demapping unit
933-1, 933-2 IDFT unit
935 P/S unit
937 demodulation unit
939 decoding unit
941 transmission signal replica generation unit
943 S/P unit
945-1, 945-2 DFT unit
1001 precoding matrix determination unit
1003 communication channel capacity calculation unit
1005 scheduling unit
1007 clipping information determination unit
1009 frequency allocation determination unit
1011 control information generation unit
1101-1, 1101-2, 1103-1, 1103-2, 1105-1, 1105-2 transmission signal
1201 scheduling unit
1203 gain calculation unit
1205-1, 1205-2 clipping information determination unit
1207-1, 1207-2 frequency allocation determination unit
1209 control information generation unit
1301-1, 1301-2 gain correction unit

1. A wireless control apparatus applied to a wireless communication system that performs clipping processing not to transmit a spectrum of part of a frequency domain to transmit and receive data, wherein
the wireless control apparatus, based on channel state information with a wireless terminal apparatus which is a destination, generates clipping information indicating a frequency domain where said clipping processing is performed and determines frequency allocation for said wireless terminal apparatus to generate frequency allocation information, and notifies said wireless terminal apparatus of said clipping information and said frequency allocation information.

2. The wireless control apparatus according to claim 1, wherein
in the case that said wireless terminal apparatus includes a plurality of transmission antennas, the wireless control apparatus independently determines clipping information for said each transmission antenna.

3. The wireless control apparatus according to claim 2, wherein
said clipping information includes at least one of information that indicates a clipping rate indicating a ratio of the frequency domain where the clipping processing is performed to the frequency domain where the clipping processing is not performed and information that indicates a frequency position where the clipping processing is performed.

4. The wireless control apparatus according to claim 2, wherein
the clipping information for said each transmission antenna is determined based on a gain of a channel corresponding to said each antenna.

5. The wireless control apparatus according to claim 4, wherein
the gain of the channel in said each transmission antenna is corrected based on a result of determination as to whether or not said clipping processing is performed on a signal in a frequency domain that is transmitted through other transmission antennas.

6. The wireless control apparatus according to claim 1, wherein
in the case that said wireless terminal apparatus includes a plurality of transmission antennas, the wireless control apparatus determines common clipping information for said each transmission antenna.

7. The wireless control apparatus according to claim 6, wherein
said clipping information includes at least one of information that indicates a clipping rate indicating a ratio of the frequency domain where the clipping processing is performed to the frequency domain where the clipping processing is not performed and information that indicates a frequency position where the clipping processing is performed.

8. The wireless control apparatus according to claim 1, wherein
said clipping information is determined based on a communication channel capacity of said wireless terminal apparatus.

9. A wireless terminal apparatus applied to a wireless communication system that performs clipping processing not to transmit a spectrum of part of a frequency domain so as to transmit and receive data, wherein
the wireless terminal apparatus receives clipping information indicating a frequency domain where the clipping processing is performed and frequency allocation information indicating frequency allocation from a wireless control apparatus which is a destination, based on said received clipping information and frequency allocation information, performs the clipping processing on the frequency domain, and converts a frequency signal on which said clipping processing is performed into a signal in a time domain to transmit to said wireless control apparatus.

10. A wireless communication system comprising the wireless terminal apparatus of claim 9.

11. A control program of a wireless control apparatus applied to a wireless communication system that performs clipping processing not to transmit a spectrum of part of a frequency domain to transmit and receive data, wherein
the control program makes a computer execute sequential processing including:
processing, based on channel state information with a wireless terminal apparatus which is a destination, to generate clipping information indicating a frequency domain where said clipping processing is performed;
processing to determine frequency allocation for said wireless terminal apparatus so as to generate frequency allocation information; and
processing to notify said wireless terminal apparatus of said clipping information and said frequency allocation information.

12-14. (canceled)
